(19) United States
(12) Patent Application Publication
(10) Pub. No.: US 2022/0335167 A1
(43) Pub. Date: Oct. 20, 2022

(54) ANALYZING ELECTRICAL RESPONSE TO DETECT UNAUTHORIZED ATTACHMENT

(71) Applicant: HEWLETT-PACKARD DEVELOPMENT COMPANY, L.P., Spring, TX (US)

(72) Inventors: Bartley Mark HIRST, Boise, ID (US); Charles LOGAN, Boise, ID (US); Cody RAVENSCROFT, Boise, ID (US)

(21) Appl. No.: 17/640,788

(22) PCT Filed: Oct. 28, 2019
(86) PCT No.: PCT/US2019/058306

§ 371 Date: Mar. 4, 2022

(51) Int. Cl. G06F 21/85; G06F 21/55

(52) U.S. Cl. CPC G06F 21/85; G06F 21/554; G06F 2221/034

(57) ABSTRACT

In various examples, detecting unauthorized attachment to a communication bus between first and second components according to the present disclosure may include: applying voltage to the communication bus between the first and second components; detecting, at the first or second component, a temporal response to the applied voltage; comparing the detected temporal response to a reference temporal response associated with the communication bus; and based on the comparing, detecting the unauthorized attachment to the communication bus.

### BACKGROUND

A “man-in-the-middle attack” is a method of compromising the security of a system wherein an unauthorized component (the eponymous “man-in-the-middle”) attaches itself to a communication channel between authorized components, impersonates an authorized component, and/or acts as a relay on the communication channel. This allows the man-in-the-middle to, for instance, gain access to the data that the two authorized components were attempting to communicate to one another. In some cases, the man-in-the-middle may selectively pass on data signals or it may generate its own signals that will fool the authorized components into thinking the signals originated from other authorized components. Such unauthorized access to a secure hardware system presents a security risk and possibly a safety risk for human users of the system, as the unauthorized components may cause dangerous conditions within the system. In many cases, man-in-the-middle attacks can be difficult to detect.

### BRIEF DESCRIPTION OF THE DRAWINGS

Features of the present disclosure are illustrated by way of example and not limited in the following figure(s), in which like numerals indicate like elements.

FIG. 1 schematically depicts how a man-in-the-middle attack may be implemented in an example environment.

FIG. 2A is a plot illustrating an example of how the attachment of an unauthorized component to the communication bus may be detected.

FIG. 2B is another plot illustrating another example of how the attachment of an unauthorized component to the communication bus may be detected.

FIG. 3 shows an example process for re-verifying the security of the communication bus after attachment of an unauthorized component has been previously detected.

FIG. 4 illustrates a technique for determining the location of the attachment of the unauthorized component on the communication bus by communicating with multiple authorized components and altering the drive strength of the communication bus.

FIG. 5 is a flowchart illustrating an example method for performing selected aspects of the present disclosure, in accordance with some examples.

FIG. 6 is an electrical diagram illustrating an example of circuitry that implements selected aspects of the present disclosure.

### DETAILED DESCRIPTION

For simplicity and illustrative purposes, the present disclosure is described by referring mainly to an example thereof. In the following description, numerous specific details are set forth in order to provide a thorough understanding of the present disclosure. It will be readily apparent however, that the present disclosure may be practiced without limitation to these specific details. In other instances, some methods and structures have not been described in detail so as not to unnecessarily obscure the present disclosure.

Additionally, it should be understood that the elements depicted in the accompanying figures may include additional components and that some of the components described in those figures may be removed and/or modified without departing from scopes of the elements disclosed herein. It should also be understood that the elements depicted in the figures may not be drawn to scale and thus, the elements may have different sizes and/or configurations other than as shown in the figures.

As noted above, unauthorized components may impersonate authorized components in a system by intercepting and relaying signals sent between authorized components. Often the signals sent by the authorized components do not make it to their intended receivers and/or the signals relayed by the unauthorized component(s) are altered or faulty. In order to prevent such unauthorized components from presenting these risks, authorized components in such a system are frequently designed to communicate using encrypted signals and/or to use authentication tests to verify any other components with which a given component is communicating.

However, these techniques for dealing with man-in-the-middle attacks have various shortcomings. In some cases, the unauthorized components can attempt to simply pass signals back and forth to sender and receiver components, as if they were not there. However, if such components are connected to such sender and/or receiver components in certain ways, such as in parallel, then the unauthorized component can affect the parasitic capacitance or impedance of the system. Such a change in the parasitic capacitance or impedance of the system can cause signals to become corrupted. In some cases, unauthorized components can be designed to learn patterns in the encrypted signals it receives and sends until it is capable of mimicking the authorized components to the degree that the “cryptographic trust” of the system is compromised.

One example of a system in which an unauthorized component may be attached to a communication bus and compromise the security and safety of the system is the example of a “governor” component meant to measure and regulate the speeds of large vehicles such that they may not exceed specific speed limits. These are often found in large trucks that are used for transporting goods on interstate highways. In such a system, a “governor” communicates with various components of the vehicle in order to accomplish its monitoring and limiting purposes. If the “governor” is replaced by an unauthorized component which may be imitating the authentic “governor”, however, then the various other components of the monitoring and limiting system may continue to attempt to communicate with the “governor” all while the monitoring and limiting system will have been compromised in such a way as to allow the vehicle to exceed the specific speed limits.

Another type of system for which techniques described herein may be implemented to detect a man-in-the-middle attack is a printing system. Many components of printing systems are modular and can be replaced as needed. However, if these components are replaced with components that are incompatible with other components of the printing system or with the printing system as a whole, the entire system and/or various constituent parts may be compromised or endangered. For example, in printing systems in which a fuser power control component has been replaced with an incompatible component, fires have resulted.

Techniques are described herein for detecting unauthorized components within systems such as those mentioned above, or in any other system that includes modular components or that has communication busses that can be tapped by unauthorized components. Techniques described herein may also prevent compromised security and safety of such a system due to man-in-the-middle attacks. In various implementations, the temporal operation of a communication bus may be measured and monitoring for deviations in the temporal response(s) of signal(s) sent and received on the bus. In some implementations, the drive strength of a communication bus may be varied on a clock-by-clock basis such that deviations in the expected temporal response of communications signals may be detected. Such deviations may indicate that communications signals are being altered, blocked, or intercepted before they are passed on. By varying the drive strength and detecting variations in the temporal response of the system, communication channels may be automatically verified on a periodic or continuous basis so that unauthorized components conducting a man-in-the-middle attack may be detected at any time during operation of the system.

In some implementations, at a time shortly after manufacture, a system controller may command or otherwise indicate to authorized components attached to a communication bus that, at various points in the future, the authorized components should verify the temporal operation of the bus. Additionally or alternatively, the system controller may command authorized component(s) to also inject their own signal alterations to the bus, e.g., by altering the drive strength via the programmable current source, to allow the system controller and/or the authorized component(s) to perform additional verifications of the temporal operation of the bus. The system controller and/or authorized component(s) may then monitor the signals sent via the communication bus to make sure that the altered signals appear at the specified time(s) and to make sure that alterations in the signals do not appear at any other times when they are not expected.

In some implementations, these alterations to the drive strength may be accomplished by attaching a programmable current source to the communication bus that the system controller and/or the authorized component(s) are able to control. In other implementations, the programmable current source itself may be an authorized component, or part of another authorized component.

By using the programmable current source to alter the current provided to the communication bus, the signals sent via the communication bus may display different voltages at different times than corresponding signals would have on the communication bus with a different drive strength. The unauthorized component attached to the communication bus will not know when to expect these drive strength alterations. Thus it is possible to detect unauthorized components attached to the communication bus through comparison of the temporal response of signals present on the communication bus to the expected temporal response of such signals sent. This adds a “physical” layer of trust to other type(s) of “cryptographic” trust that may or may not have been compromised.

Individual authorized components, groups of authorized components, and/or the system controller may verify the temporal operation of a communication bus in a variety of ways. In the simplest example, the system controller and/or authorized component(s) may examine the amount of time it takes for a received signal to fluctuate between two reference voltages, such as a minimum reference voltage and a maximum reference voltage. This time may be referred to herein as the temporal response of the signal. This temporal response is then compared to a reference temporal response, e.g., determined during manufacturing or during another time in which there is confidence that no unauthorized attachments have occurred.

If the temporal response of the signal is longer than the reference amount of time, then this may suggest that an unauthorized component has attached to the communication bus. This attachment may cause interference such that there is a small delay or alteration in the signals being relayed. Or, the attachment may allow the unauthorized component to inject its own signals onto the communication bus such as in the case where the unauthorized component is impersonating an authorized component.

If the temporal response of the signal is too short when compared to the reference temporal response, then this may be an indication that a signal originated with an unauthorized component rather than an authorized component. The temporal response of the signal being too long or too short may, additionally or alternatively, be evidence that attachment of an unauthorized component to the communication bus has altered the characteristic parasitic capacitance or characteristic impedance of the system in such a way as to cause unwanted changes in the voltage characteristics of a signal over time.

In further examples where the drive strength of the communication bus may be altered during communications, a first authorized component may send command signals indicating an action for a second authorized component to take. The first authorized component may further receive response signals from the second authorized component. These response signals may, for instance, indicate receipt of the command signal from the first authorized component (which may indicate some sort of change in status of the second authorized component or additional authorized component(s)), and/or provide information to the first authorized component that it may need for future processes.

In some cases, the first authorized component may additionally send authentication signals to the second authorized component and receive verification signals in response. These authentication signals may be sent at any time, including at times specified by the system controller, random times, before a command signal is sent in order to determine if an unauthorized component is present before said command signal is sent, after a deviation in temporal operation of the bus is detected in a response signal or a verification signal, or after signal(s) that are expected to be received by a given component are not received within a predicted amount of time.

Throughout the time that these signals are being sent and received, the system controller and/or authorized component(s) may alter the drive strength of the communication bus, e.g., on a clock-by-clock basis. The system controller and/or authorized component(s) may analyze the temporal response of signals sent and received on a clock-by-clock basis by comparing their temporal responses to expected temporal responses. The expected temporal responses may correspond to signals sent and/or received during a time in which no unauthorized components were present, such as during manufacturing, upon delivery to a deployment site, etc.

When the temporal response of the signals deviates from the expected temporal response, the authorized components may take various remedial actions. For example, they may stop sending command and/or response signals via certain portions of the communication bus until the security of the bus can be verified using authentication and verification signals. In some examples the authorized components may stop sending all signals until the system is turned off and then on, at which time the analysis of the temporal operation of the bus may be evaluated once again. In further examples, the authorized components may stop sending all signals until the system controller instructs them to begin sending command/response signals again or until the system controller instructs the authorized components to verify the security of the bus with authentication and verification signals.

These techniques for performing detection of man-in-the-middle attacks can be performed at any time by the system controller or between two or more components of a system, including between an authorized component sending a signal, an authorized component receiving a signal, and/or a system controller that controls the authorized components. In some examples, authorized component(s) and/or a system controller may monitor the signals sent and received via the communication bus and analyze the temporal response of these signals.

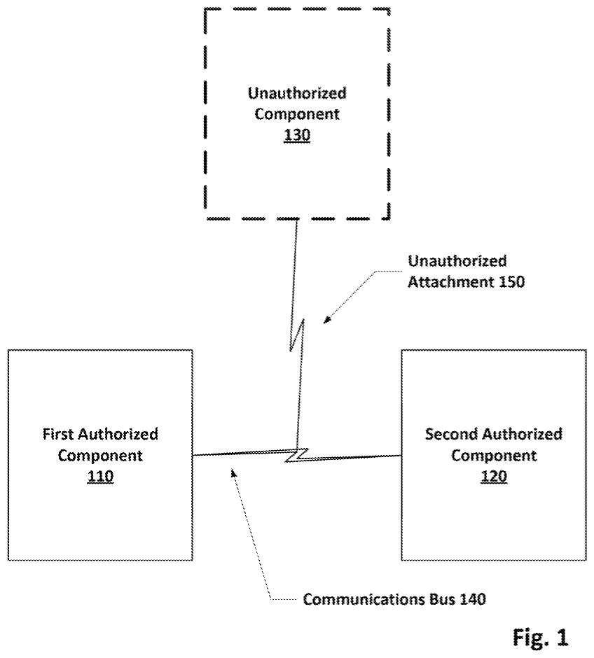

FIG. 1 illustrates an example man-in-the-middle attack. In this example, a first authorized component 110 is in communication with a second authorized component 120 via a communication bus 140. Authorized components 110, 120 may take various forms of components commonly found in various types of systems, such as printing systems, communication systems, computer systems, and so forth. Communication bus 140 may take various wired and/or wireless forms, such as a system bus, a front-side bus, a local bus, an input/output (“I/O”) bus, an Industry Standard Architecture (“ISA”) bus, an Extended Industry Standard Architecture (“EISA”) bus, a Peripheral Component Interconnect (“PCI”) bus, a Micro Channel Architecture (“MCA”) bus, an Inter-Integrated Circuit (“I2C”) bus, and so forth.

An unauthorized component 130, also known as the man-in-the-middle, has connected to communication bus 140 via an unauthorized physical or wireless attachment 150. In such a situation, the unauthorized component 130 may eavesdrop on the signals sent from the first authorized component 110 to the second authorized component 120 and vice versa. Additionally or alternatively, the unauthorized component 130 may intercept signals sent from one of the authorized components 110, 120. The unauthorized component 130 may then alter or corrupt these signals before relaying them to the other authorized component 120,110, or may simply block the signal from being relayed to the other authorized component, or may block the signal from being relayed to the other authorized component and, additionally, send it(s) own signals to the authorized component(s) 110,120.

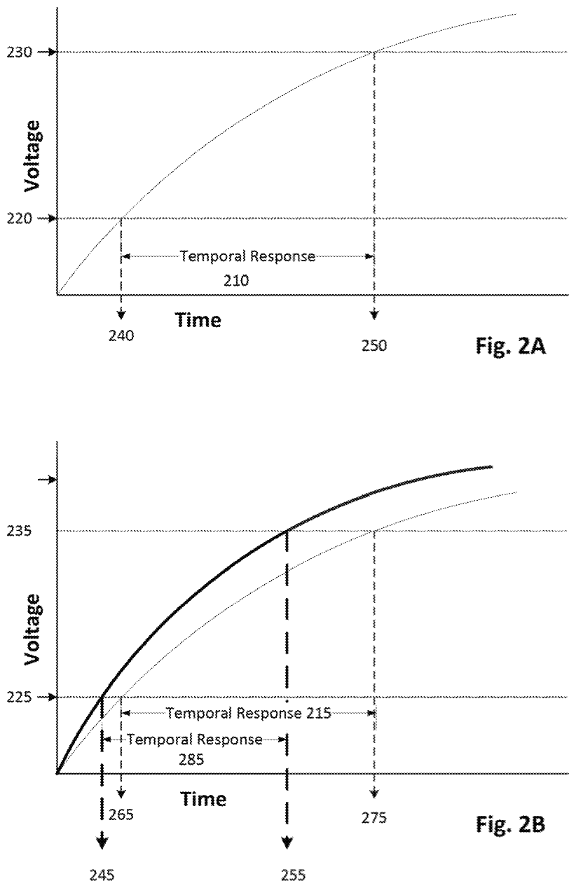

FIG. 2A shows a plot demonstrating one example of how the attachment of an unauthorized component to a communication bus may be detected while the drive strength of the communication bus is not being altered to aid in the detection. In such an example, an unauthorized component may be attached to the communication bus such that the unauthorized component causes an alteration in the parasitic capacitance or impedance of the system. These alterations in the parasitic capacitance or impedance may cause corruption of signals sent and received via the communication bus. Alternatively or additionally, the unauthorized component may alter signals it relays to the authorized components, block signals meant for the authorized components, and/or inject its own signals on the communication bus that are meant to fool the authorized components into believing that the signals originated with the system controller or another authorized component.

This illustration of FIG. 2A shows the variations of the voltage of a signal sent over the communication bus over a period of time that the system controller and/or the authorized component(s) may monitor while attempting to detect attachment of an unauthorized component to the communication bus. FIG. 2A shows that there are two reference voltages 220, 230 that the system controller or the authorized components use to detect the temporal response 210 of signals sent over the communication bus. The first reference voltage 220 occurs at the first reference time 240, and marks the time when the system controller and/or the authorized component(s) begins monitoring for the signal to reach the second reference voltage 230, which occurs at the second reference time 250.

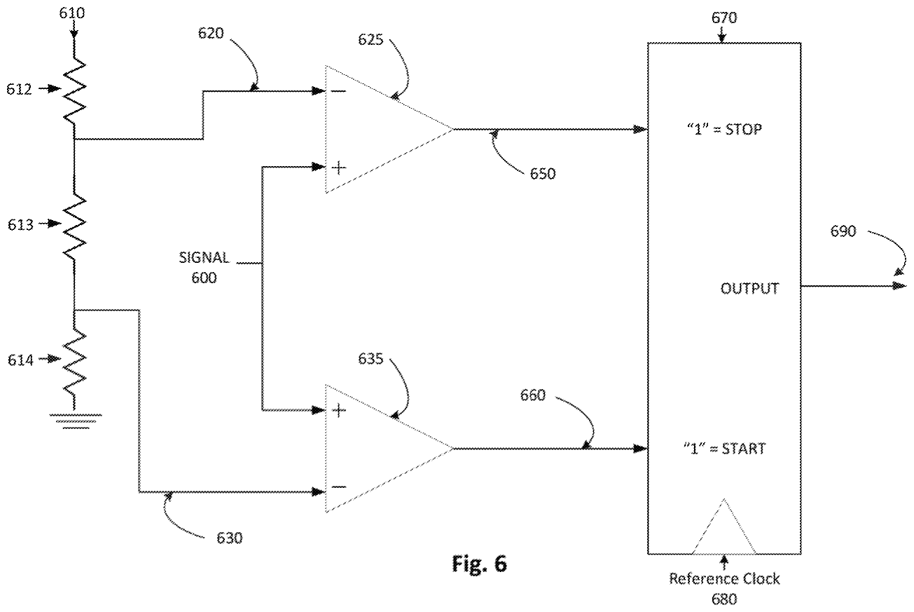

The amount of time that passes between the signal reaching the first reference voltage 220 at first reference time 240 and the signal reaching the second reference voltage 230 at second reference time 250 is referred to herein as the temporal response 210 of the signal. This temporal response 210 may be calculated by the system controller and/or the authorized component(s) using various types of circuitry. This circuitry may include, but is not limited to, a processor that executes transitory or non-transitory computer-readable instructions in memory, a field-programmable gate array (“FPGA”), an application specific integrated circuit (“ASIC”), or comparators and a timer (an example of which is depicted in FIG. 6). Such circuitry can be used to continuously and/or periodically compare the voltage of signals sent via the communication bus to the first reference voltage 220 and second reference voltage 230 of the expected signals, e.g., on a clock-by-clock basis. In some examples, a timer may start when the signal being monitored reaches the first reference voltage 220 and may stop when the signal reaches the second reference voltage 230.

If the temporal response 210 of a signal that a system controller or an authorized component is monitoring deviates from an expected temporal response of the signal, then the security of the communication bus may be considered compromised and the system controller and/or the authorized component(s) will then stop or alter the transmission of signals over the communication bus until the security of the communication bus can be verified. As mentioned previously, the reference temporal response of a signal may be a reference time that is calculated while there is sufficient confidence that no authorized components are present, such as during manufacture of the system. In some implementations, the reference temporal response may be stored in memory and/or a database (local or remote) that is accessible to the system controller and/or the authorized component(s).

Unlike FIG. 2A, FIG. 2B illustrates how a man-in-the-middle attack may be detected while the drive strength of the communication bus is being altered. In this example, the voltage characteristics over time of the expected signal will be different than they would be when sent over the communication bus while the drive strength was not being altered (as was the case in FIG. 2A).

As noted previously, an unauthorized component attached to the communication bus may intercept and relay signals sent and received from the system controller and/or the authorized component(s). Additionally or alternatively, the unauthorized component may alter the signals or inject its own signals onto the communication bus. By altering the drive strength of the communication bus on a clock-by-clock basis, the system controller and/or the authorized component(s) may be able to detect the attachment of the unauthorized component to the communication bus because the time that a signal is sent by the unauthorized component will be different than the time that a signal that has not been intercepted or altered would have been sent by an authorized component. Thus, the signal received from the unauthorized component will correspond to different drive strength alterations (or to no drive strength alterations) than the system controller and/or the authorized component(s) will expect to see on the communication bus.

In such a case where the drive strength is being altered as signals are sent and received via the communication bus, one or both of a first reference voltage 225 and a second reference voltage 235 and/or one or both of a first reference time 265 and a second reference time 275 of the expected signal may differ from those reference voltages and times (220, 230, 240, 250) of the expected signal when the drive strength is not being altered (as in FIG. 2A). This may result in the reference temporal response 215 of the expected signal differing from the reference temporal response 210 of a corresponding signal sent over the communication bus when no alterations in drive strength are made to the bus.

If an unauthorized component is attached to the communication bus while these drive strength alterations are occurring, then a signal sent over the communication bus may reach the first reference voltage 225 at an initial reference time 245. The signal may then reach the second reference voltage 235 at a final reference time 255. The difference between this initial reference time 245 and this final reference time 255 may be the temporal response 285 of the signal. This temporal response 285 of the signal sent via the communication bus may be compared to the reference temporal response 215 of a signal sent on the bus when the drive strength was being altered but when no unauthorized component was attached to the communication bus. If this temporal response 285 is greater than or less than the reference temporal response 215 of the signal, then the security of the communication bus may be considered compromised and the system controller and/or the authorized component(s) may then stop or alter the transmission of signals over the communication bus until the security of the communication bus can be verified. As in the case of FIG. 2A, the reference temporal response 215 of a signal may be a reference time that is calculated by the manufacturer of the system and that is stored in memory that is accessible to the system controller and/or the authorized component(s).

In performing these methods of detecting an attachment of an unauthorized component to the communication bus, the drive strength may be altered consistently, periodically, or randomly, on a clock-by-clock basis. Consequently, there may be multiple time intervals in which the temporal response 215 is expected to differ from the temporal response 210. This may increase the odds of being able to detect an unauthorized component performing a man-in-the-middle attack who may be sending signals via the communication bus occasionally or sporadically.

In various examples, the system controller may command the authorized component(s) to alter the drive strength based on discrepancies that the system controller has detected in signals between other authorized component(s) of the system, based on other criteria, or randomly. The system controller may also alter the drive strength of the communication bus itself rather than instructing the authorized component(s) to alter the drive strength.

The drive strength may be altered by the system controller and/or the authorized component(s) operating a programmable current source that is connected to the communication bus. The system controller and/or the authorized component(s) may be able to control the programmable current source so as to provide variable current to the bus, resulting in differing voltage characteristics over time of signals sent via the communication bus. In some examples, the drive strength may be altered to provide weak biasing to the expected signal such that even a small change in the parasitic capacitance or impedance of the system may be detected.

The examples of FIGS. 2A-B demonstrate one type of a temporal response that may be detected, but these are not meant to be limiting. In some examples, temporal responses and/or changes in temporal responses may be determined based on electromagnetic wave reflections off of impedance discontinuities that might be caused by unauthorized man-in-the-middle components. In some examples, temporal responses and/or changes in temporal responses may be determined based on alteration of characteristic impedance of a bus, and/or based on measured changes of a voltage standing wave ratio (“VSWR”). In some examples, a temporal response and/or a changes in a temporal response may be determined based on a detected change in an impedance response of a communication bus.

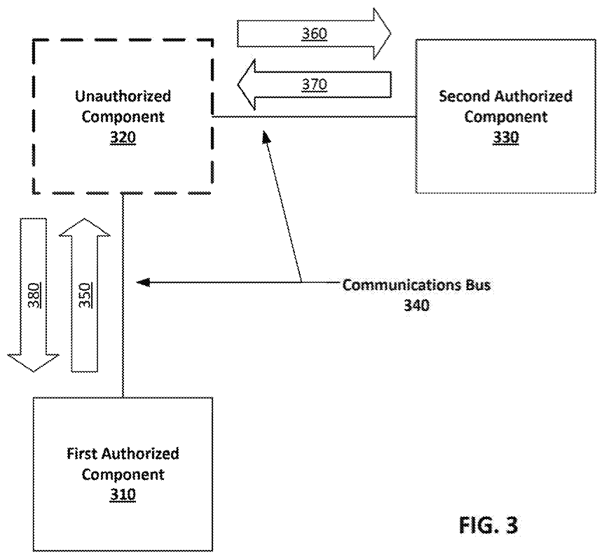

FIG. 3 demonstrates an example process for verifying the security of the communication bus after a security compromise has been detected. By performing a process such as that depicted in FIG. 3, the system controller and/or the authorized component(s) may resume sending and responding to signals, resume certain processes, or cease notifying the user of an unauthorized component once the security is verified.

FIG. 3 depicts a first authorized component 310 that is attempting to communicate with a second authorized component 330 via communication bus 340 while an unauthorized component 320 eavesdrops on or interferes with the communication. In this example, the first authorized component 310 may be the system controller or may be another authorized component of the system. The first authorized component 310 and/or the second authorized component 330 may monitor signals 350, 360, 370, 380 that they exchange via the communication bus 340.

In this example, the drive strength of the communication bus 340 is being altered. e.g., by the authorized component(s) 310, 330, so that unauthorized components 320 attached to the communication bus 340 may be detected. The drive strength of the communication bus 340 may be altered constantly, randomly, or at specific times on a clock-by-clock basis. The authorized component(s) 310, 330 may analyze the temporal response of the signals sent and received on the communication bus 340 during the time periods when the drive strength of the communication bus 340 is being altered.

In such an example, the authorized component(s) 310, 330 may not yet detect that an unauthorized component 320 is intercepting, relaying, blocking, or generating the signals 350, 370, 360, 380. Additionally or alternatively, the authorized component(s) 310, 330 may be operating under the assumption that unauthorized component 320 is an authorized component, when in reality it has been replaced with an unauthorized component 320.

Signals 360, 380 generated by the unauthorized component 320 over the communication bus 340 while the drive strength is being altered will be different than they would be if sent over the communication bus 340 while the drive strength is not being altered. This may be because the signals 360, 380 are relayed or generated by the unauthorized component 320 at different times than they would be if they were not being intercepted before they are relayed or if a signal had actually originated with the authorized component that the unauthorized component 320 is imitating. They will also differ from authentic signals sent from the authorized component(s) 310, 330 because the alterations to the drive strength will be difficult for the unauthorized component 320 to predict and to imitate in order to fool the authorized components 310, 330 into believing that the signals 360, 380 originated from one of the authorized components 330, 310. Thus the signals 360, 380 sent by the unauthorized component 320 will correspond to signals with different drive strengths than the signals 350, 370 that the authorized component(s) 310, 330 expect to be sent from authorized components.

These drive strength alterations will cause the signals 360, 380 received by the authorized component(s) 330, 310 to have different temporal responses than the signal(s) 350, 370 that the authorized component(s) 330, 310 expect to receive. In one example, the first authorized component 310 sends a command signal 350 via the communication bus 340 and expects to receive a response signal 370 with a particular temporal response via the communication bus. Due to the alterations in the drive strength, the signal 360 that the unauthorized component 320 ultimately passes on to the second authorized component 330 will have a temporal response that does not correspond to the expected temporal response of the signal 350 that the authorized component(s) 310, 330 expect to be sent if the signal 360 originated with the first authorized component 310 and had not been subject to any interference.

Likewise, the second authorized component 330 may transmit a responsive signal 370 that is meant for the first authorized component 310. Due to the alterations in the drive strength over the relevant period of time, however, the actual signal 380 ultimately received by the first authorized component 310 may not have the expected temporal response of the expected signal 370. When such deviations in the temporal responses of signals sent and received via the communication bus 340 are detected, the security of the communication bus 340 may be considered compromised.

One or both authorized components 310, 330 may then begin transmitting additional authentication signals 350, 370, also while the drive strength is being altered, to which they expect to receive verification signals 370, 350 from one another in response. The drive strength alterations may cause the signals 360, 380 originating from or relayed by the unauthorized component 320 to differ from the expected signals 350, 370. In particular, the verification signals 360, 380 received from the unauthorized component 320 may have a different temporal response than the verification signals 350, 370 that the authorized component(s) 310, 330 expected to receive. This deviation in temporal response may signal that the system is compromised.

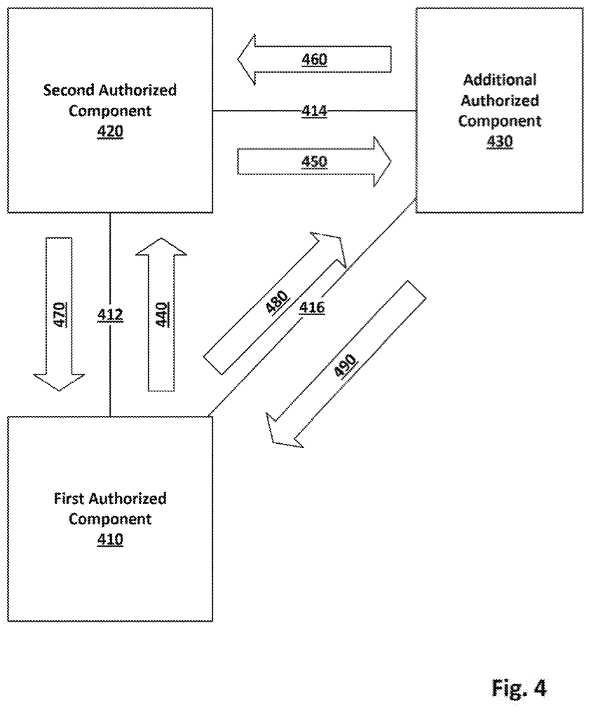

FIG. 4 depicts various authorized components of a system working together to locate an unauthorized component that has attached to the communication bus. In FIG. 4, a first authorized component 410 is in communication with a second authorized component 420 over a first communication bus portion 412. An additional authorized component 430 is in communication with the second authorized component 420 over a second communication bus portion 414. In some examples, the first authorized component 410 may be the system controller. The first authorized component 410 may also be in direct communication with the additional authorized component 430 over a third communication bus portion 416, or may be in indirect communication with the additional authorized component 430 through various other authorized component(s) (e.g., 420) or through unauthorized components attached to the communication bus.

In the example of FIG. 4, the first authorized component 410 and the second authorized component 420 or the additional authorized component 430 work together to detect the communication bus portion (e.g., 412, 414, or 416) at which an unauthorized component is attached. These detections may be made, for instance, by identifying that communication interference exists on a portion of the communication bus, then altering the drive strength at various times or constantly, on a clock-by-clock basis, and monitoring the signals sent between various components.

In the example shown in FIG. 4, the first authorized component 410 may send a command signal 440 directly to the second authorized component 420. The command signal 440 may cause the second authorized component 420 to send distinct command signals 450 to additional authorized component 430. These distinct command signals 450 may convey commands to the additional authorized component 430. For example, these command signals 450 may, for instance, instruct the additional authorized component 430 to perform some action that causes its status to change. The command signals 450 may additionally or alternatively provide information to the additional authorized component 430 that can later be queried by the first authorized component 410, e.g., to ensure that the additional authorized component 430 has received the information.

The first authorized component 410 may then send its own command signals or authentication signals 480 directly to the additional authorized component 430, and may receive signals 490 in response that may, e.g., communicate the change in status or receipt of information by the additional authorized component 430. The first authorized component 410 may compare these received signals 490 to their corresponding expected signals to determine whether the second authorized component 420 successfully communicated the information or caused the given additional authorized component 430 to change its status.

A failure to communicate the information or cause the change in status of the additional authorized component 430 may be due to various factors. For example, an authorized component that is involved in the chain of communications (e.g., 420) may disregard a signal it receives because it does not correspond to an expected signal. Additionally or alternatively, an authorized component may receive a corrupted or counterfeit signal from an unauthorized component.

In some cases, the first authorized component 410 may receive “indirect” response or verification signal(s) 470 from the second authorized component 420. These “indirect” response or verification signal(s) may be based on response or verification signal(s) 460 received by the second authorized component 420 from the additional authorized component 430. The first authorized component 410 may compare these “indirect” signal(s) 470 to “direct” signal(s) 490 received directly from the additional authorized component 430. Any deviation between “indirect” signal(s) 470 and “direct” signals 490 may signal compromise of the system, which may be the result of an unauthorized attachment by a man-in-the-middle.

When the authorized component(s) 410, 420, 430 detect such a communications failure, they may then begin exchanging signals with other authorized component(s) the drive strength of the communication bus 412,414, 416 is altered in order to triangulate where on the communication bus 412,414, 416 the communications failure occurred, thus identifying where an unauthorized component has attached to the communication bus 412,414, 416.

As mentioned above, the drive strength may be altered by the authorized component(s) 410, 420, 430 via controlling a programmable current source that is connected to the communication bus 412,414, 416. The signals relayed or generated by an unauthorized component will not be generated or sent at the same times as the signals sent by the authorized components of the system. Additionally, legitimate signals exchanged between authorized components of the system will be hard to imitate since the drive strength alterations will be hard for the unauthorized component to predict. Consequently, temporal responses of signals sent by the unauthorized component may differ from reference temporal responses associated with legitimate signals transmitted by authorized component(s).

In some examples, while the drive strength is being altered, the authorized component(s) of the system may work together in pairs or groups to send command or authentication signals 440, 450, 480 to various other authorized components of the system. These command or authentication signals may instruct the other authorized component(s) to communicate information and/or cause each other to experiences changes in status. These authorized components may then be queried to receive response or verification signals 460, 470, 490 to confirm that the information was communicated or the change in status completed. The authorized component(s) 410, 420, 430 may also compare the temporal response of the response signals 460, 470, 480 they receive to expected temporal response(s).

By analyzing signals received from two or more components to determine if any one communications task has been completed, the authorized component(s) may be able to triangulate exactly where a communications failure occurred. This will allow the authorized component(s) to locate a point on the communication bus (e.g., at 412, 414, or 416) between two authorized components that an unauthorized component has attached to the communication bus.

For example, the first authorized component 410 may analyze information received in signals 470 and 490 and determine that there has been a communications failure between the second authorized component 420 and the additional authorized component 430. The first authorized component may then use other additional authorized component(s) to determine that communication bus 414 between the second authorized component 420 and the additional authorized component 430 is the point on communication bus where communications are being compromised, e.g., by an unauthorized component.

Once the unauthorized component is triangulated, authorized component(s) 410,420, 430 may take various remedial actions. These remediation actions may include, but are not limited to, isolating that component by routing signals through other authorized components so as to avoid sending signals to the unauthorized component, ignoring signals received from the unauthorized component, storing information about the unauthorized component in a database, ceasing certain processes, and/or notifying the user of the system of the unauthorized component. Any of these remedial actions may occur for as long as the unauthorized component is detected, until the security of the system can be verified, or until the system controller sends commands to the affected components to resume normal communication operations.

In some examples, various components that share a communication bus may take turns playing the roles of the various authorized component(s) depicted in the above examples of FIGS. 3 and 4, e.g., until all of the components that share the communication bus are authenticated and the security of the communication bus is verified, until components are confirmed to be unauthorized components, or until it is confirmed that the security of the communication bus has been compromised. This process may occur at specific times, random times, whenever the system is powered off and then on, any time abnormal temporal operation of the bus has been detected, or at times specified by instructions from the system controller.

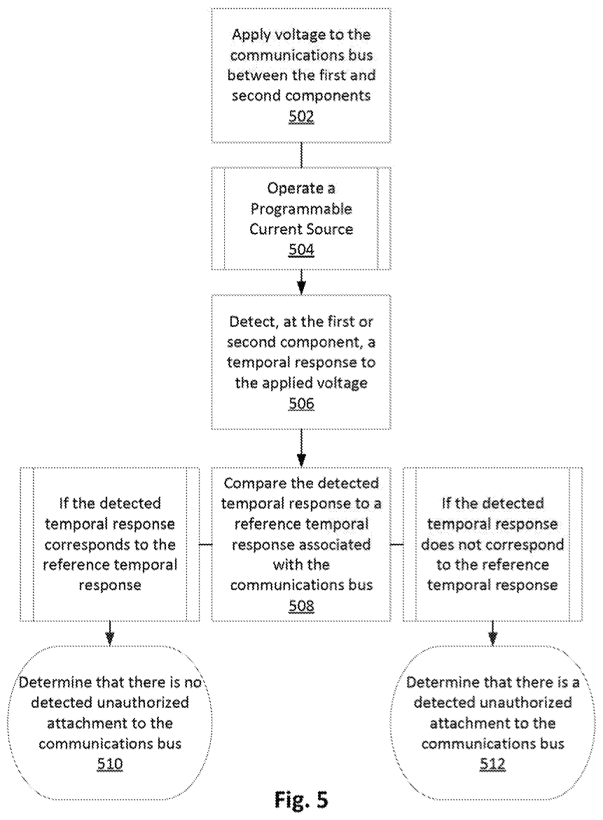

FIG. 5 illustrates a flowchart of an example method 500 for practicing selected aspects of the present disclosure. The operations of FIG. 5 may be performed by various authorized components (e.g., 110, 120, 130, 310, 320, 330, 410, 420, 430) described herein. For convenience, operations of method 500 will be described as being performed by a system configured with selected aspects of the present disclosure. Other implementations may include additional operations than those illustrated in FIG. 5, may perform operations (s) of FIG. 5 in a different order and/or in parallel, and/or may omit various operations of FIG. 5.

At block 502, the system may apply a voltage to communication bus between a first authorized component and a second authorized component. In some examples, this may involve sub-process 504 in which a programmable current source is operated in applying the voltage.

At block 506, the system detects, at the first authorized component or the second authorized component, a temporal response to the applied voltage. In some examples, this detecting may include measuring a time interval between fluctuations of the applied voltage between known voltages. In some such examples, the measuring may be performed using a comparator and a timer, such as those depicted in FIG. 6.

At block 508, the system compares the detected temporal response to a reference temporal response associated with the communication bus. If the detected temporal response corresponds to the reference temporal response, then the system determines at block 510 that an unauthorized component is not attached to the communication bus. If the detected temporal response does not correspond to the reference temporal response, on the other hand, then the system determines at block 512 that an unauthorized component is attached to the communication bus.

FIG. 6 is an electrical diagram illustrating a non-limiting example of how selected aspects of the present disclosure may be implemented. As shown, various combinations of a high reference voltage 620, a low reference voltage 630, and a signal 600 under consideration are fed into comparators 625, 635. The signal 600 may be the signal that is being analyzed to determine whether a man-in-the-middle is attached to the system. The high reference voltage 620 may correspond, for instance, to elements 230 and 235 in FIGS. 2A-B. The low reference voltage 630 may correspond, for instance, to elements 220 and 225 in FIGS. 2A-B.

The outputs of the comparators 625, 635, respectively, are a stop signal 650 and a start signal 660. Stop signal 650 and start signal 660 are fed into a counting circuit 670 with a reference clock 680. The counter circuit 670 counts clock cycles of reference clock 680 that elapse between when it receives a “1” for the start signal 660 from comparator 635 until it receives a “1” for the stop signal 650 from comparator 625.

Comparator 635 compares the low reference voltage 630 to the signal 600 and outputs a “0” start signal 660 until the signal 600 has a voltage greater than (and/or equal to) the low reference voltage 630, at which time comparator 635 outputs a “1” start signal 660. At that time, and as mentioned previously, counter circuit 670 begins counting reference clock 680 cycles.

Similarly, comparator 625 compares the high reference voltage 620 to the signal 600 and outputs a “0” stop signal until the signal 600 has a voltage greater than (and/or equal to) the high reference voltage 620, at which time comparator 625 outputs a “1” stop signal. At that point, and as described previously, the counter circuit 670 stops counting reference clock 680 cycles and outputs the number of reference clock 680 cycles that it counted as the counted value 690. The counted value 690 is then used to calculate the temporal response of the signal 600.

This temporal response of signal 600 is then compared to a reference temporal response of a signal that the master device and/or the authorized components expect to see.

In some examples, the high reference voltage 620 and low reference voltage 630 may be determined based on a reference voltage 610 and resistor values for a resistor divider network that includes resistors 612, 613, and 614. The use of the resistor divider network (612, 613, and 614) should be understood to merely be a non-limiting example of how the high reference voltage 620 and low reference voltage 630 may be provided to comparators 625 and 635. It should be understood that these reference voltages 620, 630 may be determined and provided to the comparators 625, 635 using other techniques, such as through the use of integrated circuits.

Although described specifically throughout the entirety of the instant disclosure, representative examples of the present disclosure have utility over a wide range of applications, and the above discussion is not intended and should not be construed to be limiting, but is offered as an illustrative discussion of aspects of the disclosure.

What has been described and illustrated herein is an example of the disclosure along with some of its variations. The terms, descriptions and figures used herein are set forth by way of illustration and are not meant as limitations. Many variations are possible within the scope of the disclosure, which is intended to be defined by the following claims—and their equivalents—in which all terms are meant in their broadest reasonable sense unless otherwise indicated.

What is claimed is:

1. A method for detecting unauthorized attachment to a communication bus between first and second components, comprising:
applying voltage to the communication bus between the first and second components;
detecting, at the first or second component, a temporal response to the applied voltage;
comparing the detected temporal response to a reference temporal response associated with the communication bus; and
based on the comparing, detecting the unauthorized attachment to the communication bus.

2. The method of claim 1, wherein applying voltage comprises modulating the voltage across a plurality of clock cycles.

3. The method of claim 2, wherein the detecting comprises detecting the temporal response across the plurality of clock cycles.

4. The method of claim 1, wherein applying voltage comprises operating a programmable current source.

5. The method of claim 4, wherein the programmable current source comprises the first or second component.

6. The method of claim 4, wherein applying voltage comprises operating the programmable current source to provide weak biasing, and wherein the detecting comprises detecting a change in a capacitance of the communication bus.

7. The method of claim 1, wherein the detecting comprises measuring a time interval between fluctuations of the applied voltage between known voltages.

8. The method of claim 7, wherein the measuring is performed using a comparator and a timer.

9. A system comprising:
a communication bus;
a first component electrically coupled to a first location of the communication bus;
a second component electrically coupled to a second location of the communication bus; and
circuitry to:
sense a change in a response of the communication bus to an applied voltage; and
in response to the sensed change, provide a notification of an unauthorized attachment to the communication bus.

10. The system of claim 9, wherein the change comprises a change in an impedance response of the communication bus.

11. The system of claim 9, wherein the change comprises a change in a temporal response of the communication bus to the applied voltage.

12. The system of claim 11, further comprising a comparator and a timer to sense the change in the temporal response of the communication bus to the applied voltage.

13. The system of claim 9, further comprising a programmable current source to modulate the applied voltage.

14. An apparatus comprising:
an interface to connect the apparatus to a communication bus; and
circuitry to:
perform a comparison of a temporal response of the communication bus to a modulated current applied to the communication bus; and
based on a result of the comparison, detect unauthorized attachment to the communication bus.

15. The apparatus of claim 14, wherein the circuitry is to modulate the applied current in a predetermined manner over a time interval, and to perform the comparison over the same time interval.
